(19) United States
(12) Patent Application Publication
(10) Pub. No.: US 2023/0249658 A1
(43) Pub. Date: Aug. 10, 2023

(54) ELECTRIC ACTUATOR AND ELECTRIC BRAKING DEVICE FOR VEHICLE USING ELECTRIC ACTUATOR

(71) Applicant: ADVICS CO., LTD., Kariya-shi, Aichi-ken (JP)

(72) Inventors: Takayuki WAZAKI, Kariya-shi, Aichi-ken (JP); Satoshi HIRATA, Kariya-shi, Aichi-ken (JP)

(73) Assignee: ADVICS CO., LTD., Kariya-shi, Aichi-ken (JP)

(21) Appl. No.: 18/002,890

(22) PCT Filed: Jun. 25, 2021
(86) PCT No.: PCT/JP2021/024209

§ 371 Date: Dec. 22, 2022

(30) Foreign Application Priority Data
Jun. 26, 2020 (JP) 2020-110412

(51) Int. Cl. B60T 13/74; F16H 25/20; F16D 51/22; B60T 1/06; F16D 65/22

(52) U.S. Cl. CPC B60T 13/746; B60T 1/067; F16D 51/22; F16D 65/22; F16H 25/2015; F16D 2121/24

(57) ABSTRACT

An electric actuator includes an input member that is rotationally driven by the electric motor and includes a first rotation stop part on an inner periphery, an output member that includes a second rotation stop part engageable with the first rotation stop part, and a first screw part on an outer periphery, and a linear motion member that includes a second screw part engageable with the first screw part. Both the screw mechanism and the rotation-stop mechanism are formed on the outer periphery of the output member. Therefore, in the electric actuator, the radial and axial dimensions are shortened.

### TECHNICAL FIELD

The present disclosure relates to an electric actuator and an electric braking device for a vehicle using the electric actuator.

### BACKGROUND ART

Patent Literature 1 describes that for the purpose of “improving a drum brake”, “during the operation and actuation of the drum brake, while the force applied to the pressing members 44a and 44b is smaller than the set value, a rotary input member 52 and a rotary slide member 53 are rotated with the rotation of the electric motor, a driving member 54 is moved in the axial direction through a screw mechanism 84, and the pressing member 44a is moved forward. Furthermore, the pressing member 44b is moved forward by the movement of the rotary slide member 53 in the axial direction. When the pair of pressing members 44a and 44b abuts on the brake shoes 30a and 30b and the applied force becomes greater than or equal to the set value, the screw mechanism 84 is locked, and thus the driving member 54 is rotated together with the rotary slide member 53, a ball lamp mechanism 90 is operated and actuated, and the pressing members 44a and 44b are moved forward. As a result, the brake shoes 20a and 20b are pressed against the drum, and the drum brake is operated.”

Specifically, Patent Literature 1 describes the following configuration.

“The rotary slide member 53 has a hollow cylindrical portion 66 extending in the axial direction and a head part 68 provided at one end portion, and is held by the rotary input member 52 so as to be relatively non-rotatable and relatively movable in the axial direction in the cylindrical portion 66. The shaft portion 78 of the rotary slide member 53 is a spline shaft, the rotary input member 52 is formed with a spline hole 72, and the rotary slide member 53 is held by the rotary input member 52 by fitting the spline shaft and the spline hole 72. The spline shaft and the spline hole 72 constitute a rotary slide mechanism 74.The driving member 54 has a solid shaft portion 78 extending in the axial direction and a head part 80 provided at one end portion, and is held on the inner peripheral side of the cylindrical portion 66 of the rotary slide member 53 in the shaft portion 78 so as to be relatively movable in the axial direction. A female screw part 81 is formed on an inner peripheral surface of the cylindrical portion 66 of the rotary slide member 53, and a male screw part 82 is formed on an outer peripheral surface of the shaft portion 78 of the driving member 54, where these screw parts are screwed fitted to form a movement conversion mechanism 84 that converts rotation into linear movement.”

In the configuration of Patent Literature 1, a movement conversion mechanism (“power conversion mechanism”, also referred to as “screw mechanism”) is provided at the center portion of a rotary slide mechanism (also referred to as a “rotation-stop mechanism”). That is, the rotation-stop mechanism (e.g., a spline mechanism) and the screw mechanism (e.g., a trapezoidal screw) are concentrically disposed. In other words, the rotation-stop mechanism and the screw mechanism are separate mechanisms, and the rotation-stop mechanism is provided on the outer side of the screw mechanism. Therefore, the dimension (size) of the mechanism as a whole increases (thickens) in the radial direction.

In addition, in order to reduce the radial dimension of the mechanism, a configuration in which the rotation-stop mechanism and the screw mechanism are separately arranged on the rotation axis line (also referred to as a “center axis line”) of the rotation-stop mechanism can be considered. However, in this configuration, the radial dimension can be shortened, but the dimension in the direction along the center axis line is enlarged. For this reason, in the electric actuator that converts the rotation power of the electric motor into the linear power and transmits the linear power, it is desired that both the radial dimension and the axial dimension can be shortened.

### CITATIONS LIST

### Patent Literature

Patent Literature 1: Japanese Unexamined Patent Application Publication No. 2010-249314

### SUMMARY

### Technical Problems

An object of the present disclosure is to provide an electric actuator used for an electric braking device for a vehicle, in which the radial and axial dimensions can be shortened and the device can be miniaturized.

### Solutions to Problems

An electric actuator (DN) according to the present disclosure includes an “input member (BI) that is rotationally driven by an electric motor (MT) and includes a first rotation stop part (Ma) on an inner periphery (Mn)”, an “output member (BO) that includes a second rotation stop part (Mb) engageable with the first rotation stop part (Ma) and a first screw part (Na) on an outer periphery (Mg)” and a “linear motion member (BH) that includes a second screw part (Nb) engageable with the first screw part (Na)”.

According to the above configuration, the screw mechanism NJ (Na + Nb) and the rotation-stop mechanism MD (Ma + Mb) are not separately provided, and both the screw mechanism NJ and the rotation-stop mechanism MD are formed on the outer periphery Mg of the output member BO. Therefore, in the electric actuator DN, the radial and axial dimensions are shortened, and the entire device can be miniaturized.

An electric braking device (DS) for a vehicle according to the present disclosure converts rotation power of an electric motor (MT) into linear power, and the linear power causes a brake lining (MS) provided on a brake shoe (BSa, BSb) to be pressed against a brake drum (BD) to generate braking force (Fx, Fp) on a wheel. A power conversion mechanism (HN) that converts the rotation power into the linear power includes an “input member (BI) including a first rotation stop part (Ma) on an inner periphery (Mn)”, an “output member (BO) including a second rotation stop part (Mb) engageable with the first rotation stop part (Ma) and a first screw part (Na) on an outer periphery (Mg)”, and a “linear motion member (BH) including a second screw part (Nb) engageable with the first screw part (Na)”.

The space around the wheels of the vehicle is narrow and very limited. According to the above configuration, since the power conversion mechanism HN is miniaturized, mountability in a narrow space can be enhanced in the electric braking device DS.

### BRIEF DESCRIPTION OF DRAWINGS

FIG. 1 is a schematic view for explaining an electric braking device DS.

FIG. 2 is a schematic view (including a cross-sectional view) for explaining an electric actuator DN.

FIG. 3 is a cross-sectional view for explaining a first example of a power conversion mechanism HN of the electric actuator DN.

FIG. 4 is a cross-sectional view for explaining a second example of a power conversion mechanism HN of the electric actuator DN.

### ELECTRIC BRAKING DEVICE DS

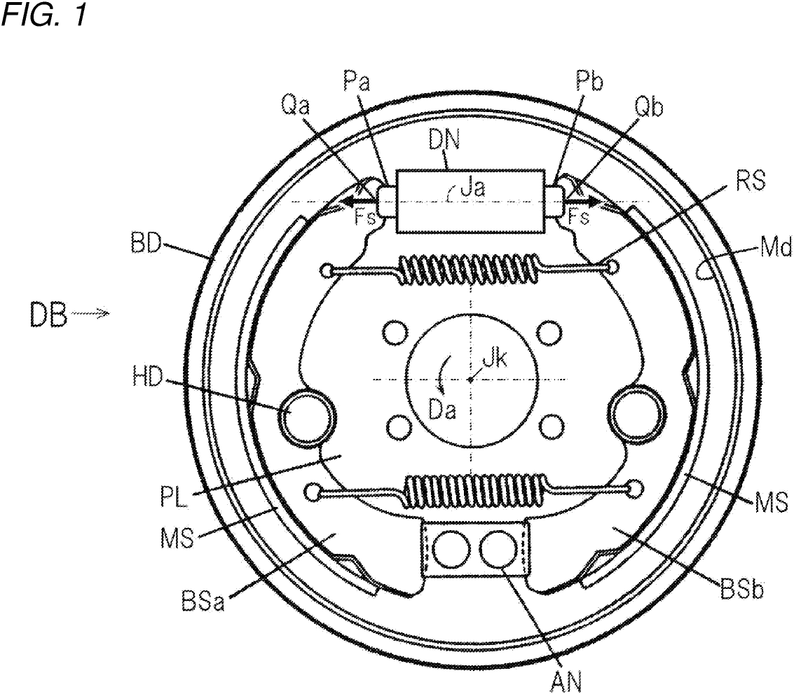

An electric braking device DS that generates a braking force on a wheel (e.g., rear wheel) of a vehicle will be described with reference to a schematic view of FIG. 1. The electric braking device DS generates a braking force on the wheel by applying a braking torque to the wheel. The electric braking device DS includes a braking device DB and an electric actuator DN. Note that in the following description, configuring members, elements, signals, characteristics, and the like denoted with the same symbol such as “MT” have the same functions.

### Braking Device DB

The braking device DB is provided on a wheel (rear wheel). As the braking device DB, a known drum type brake (e.g., leading-trailing type) is adopted. The braking force for decelerating the vehicle (referred to as “deceleration braking force Fx”) and the braking force for maintaining the stop state of the vehicle (referred to as “parking braking force Fp”) are generated by the braking device DB. The deceleration braking force Fx and the parking braking force Fp are generated using an electric actuator (also simply referred to as an “actuator”) DN described later as a power source. The deceleration braking force Fx is used for the service brake, and the parking braking force Fp is used for the parking brake, respectively.

The braking device DB is fixed to the wheel side. The braking device DB includes a backing plate PL, a brake drum BD, and brake shoes BSa and BSb.

The braking device DB includes a backing plate PL, which is a non-rotating member, and a brake drum BD, which has a friction surface Md on the inner peripheral side and rotates integrally with the wheel about a rotation axis Jk of the wheel. An anchor member AN and an electric actuator DN are respectively fixed to diametrically distant sites of the backing plate PL. A pair of brake shoes BSa and BSb each having an arc shape is provided between the anchor member AN and the electric actuator DN (in particular, sites Pa, Pb) in a state of facing the friction surface (inner peripheral surface) Md of the brake drum BD. In other words, the two brake shoes BSa and BSb are extended in an arc shape along the inner peripheral surface Md of the cylindrical brake drum BD. The brake shoes BSa and BSb are attached movably along the surface of the backing plate PL by the shoe hold down HD.

A brake lining MS (friction material) is baked on the outer peripheral surfaces of the brake shoes BSa and BSb. One end portion Qa, Qb of the pair of brake shoes BSa and BSb is engaged with the electric actuator DN, and the other end portion is abutted on the anchor member AN to be supported in an expandable manner.

A return member (e.g., return spring) RS is provided between the pair of brake shoes BSa and BSb. When the pressing of the brake shoes BSa and BSb is released by the return member RS, the brake shoes BSa and BSb are moved away from the inner peripheral surface Md of the brake drum BD.

Further, a strut with an adjuster (not illustrated) is provided between the pair of brake shoes BSa and BSb. The gap between the brake lining MS and the drum friction surface Md is adjusted according to the wear of the brake lining MS by the strut with the adjuster.

The lower end portions of the brake shoes BSa and BSb are supported at the lower side of the backing plate PL so as to be rotatable about the anchor member AN. The electric actuator DN is supported at the upper side of the backing plate PL. The electric actuator DN has two movable parts Pa and Pb (“first and second pressing parts”) that can project out in a direction of a pressing axis line Ja (described later) (coinciding with a vehicle front-rear direction). The first and second pressing parts Pa and Pb are projected out by the power of the electric motor MT.

For example, when the electric motor MT is driven in the forward rotation direction, the first and second pressing parts Pa and Pb project out (expand along the pressing axis line Ja). As a result, the pressing force Fs is applied to the upper end portions (one end portions) Qa and Qb of the brake shoes BSa and BSb, and the brake lining MS is pressed against the inner peripheral surface (friction surface) Md of the brake drum BD. A braking torque is applied to the brake drum BD by friction between the brake lining MS and the inner peripheral surface Md, and the wheel is braked. That is, the brake lining MS is pressed against and brought into sliding contact with the friction surface Md of the brake drum BD via the electric actuator DN, whereby a friction force is generated between the brake lining MS and the brake drum BD. This friction force generates and increases the braking force on the wheel.

When the braking force of the wheel is reduced, the electric motor MT is driven in the reverse rotation direction, and the projections of the first and second pressing parts Pa and Pb are contracted. As a result, the pressing force Fs acting on the upper end portions Qa and Qb of the brake shoes BSa and BSb is reduced, and the friction force between the brake lining MS and the brake drum BD is reduced. At the time of non-braking, the brake shoes BSa and BSb are pulled back by the return member RS, and thus the brake lining MS is separated from the friction surface Md.

### Electric Actuator DN

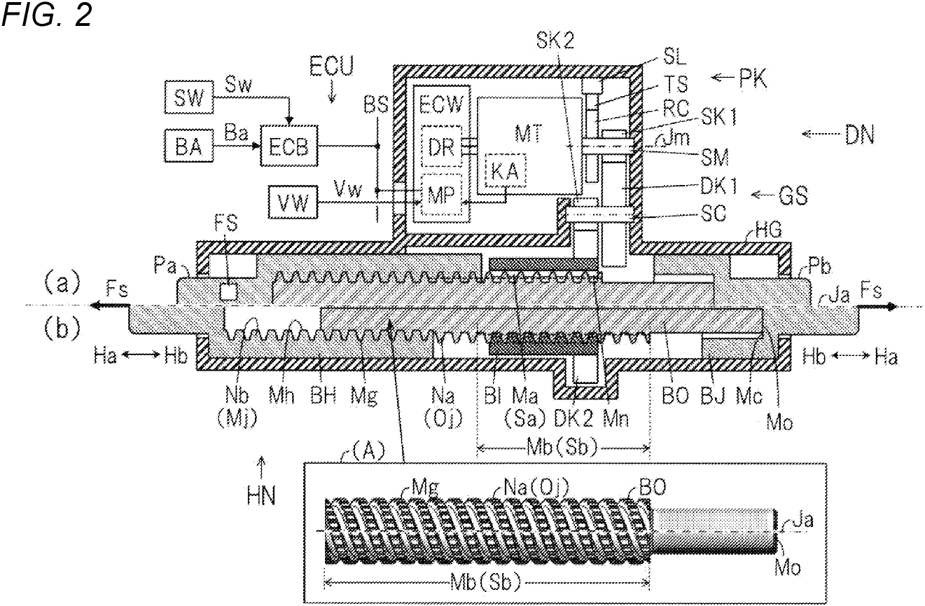

The electric actuator DN will be described with reference to a schematic view (including a partial cross-sectional view) of FIG. 2. The actuator DN includes a housing HG, an electric motor MT, a speed reducer GS, a power conversion mechanism HN, a parking brake mechanism PK, and a controller ECU.

The housing HG supports the electric motor MT, the speed reducer GS, and the power conversion mechanism HN, and covers these configuring members. The electric actuator DN is fixed to the backing plate PL by way of the housing HG. A part of the electric actuator DN (in particular, a member around the pressing axis line Ja including the input member BI, the output member BO, and the first and second linear motion members BH and BJ) is provided on the same side as the brake shoes BSa and BSb with respect to the backing plate PL. On the other hand, the other members (e.g., electric motor MT and wheel-side controller ECW) of the electric actuator DN are provided on the side opposite to the brake shoes BSa and BSb with respect to the backing plate PL. That is, the actuator DN is disposed so as to penetrate the backing plate PL.

The electric motor MT is a power source for generating the braking force Fx and the parking braking force Fp. The electric motor MT is driven by a controller (also referred to as an “electronic control unit”) ECU. As the electric motor MT, a motor with a brush or a brushless motor is adopted. When the electric motor MT is driven in the forward rotation direction, the pressing force Fs is increased, and the braking forces Fx and Fp are increased. On the other hand, when the electric motor MT is driven in the reverse rotation direction, the pressing force Fs is reduced, and the braking forces Fx and Fp are reduced. The electric motor MT is provided with a rotation angle sensor KA so as to detect a position (rotation angle) Ka of a rotor (rotor) of the electric motor MT.

The rotation power of the electric motor MT (output torque of the electric motor MT around the motor axis line Jm) is reduced by the speed reducer GS. The speed reducer GS includes a plurality of gears (e.g., two gear trains). The first small-diameter gear SK1 is fixed to the output shaft SM of the electric motor MT. The intermediate shaft SC is provided, and the first large-diameter gear DK1 is fixed to the intermediate shaft SC so as to mesh with the first small-diameter gear SK1. Furthermore, the second small-diameter gear SK2 is fixed to the intermediate shaft SC. The second small-diameter gear SK2 is disposed so as to mesh with the second large-diameter gear DK2. That is, the rotation power of the electric motor MT is decelerated by the power transmission path of “SK1 → DK1 → SK2 → DK2” and input to the power conversion mechanism HN via the speed reducer GS (in particular, second large-diameter gear DK2).

### Power Conversion Mechanism HN

The rotation power (i.e., rotation power of the electric motor MT) of the second large-diameter gear DK2 is converted into linear power by the power conversion mechanism HN and is output to the brake shoes BSa and BSb as the pressing force Fs. That is, the rotary motion of the electric motor MT is converted into the linear motion by the power conversion mechanism HN. The power conversion mechanism HN includes an input member BI, an output member BO, and first and second linear motion members BH and BJ.

The input member BI is a rotating member having a cylindrical shape (member rotatable with respect to the housing HG), and the second large-diameter gear DK2 is fixed to an outer periphery (cylindrical outer periphery) thereof. That is, the input member BI is rotationally driven by the electric motor MT, and the second large-diameter gear DK2 and the input member BI are coaxial. The rotation axis line Ja of the input member BI is called a “pressing axis line”. A first rotation stop part Ma is provided on the inner periphery (cylindrical inner periphery) Mn of the input member BI. For example, the first rotation stop part Ma is formed (processed) as a spline internal tooth. In this case, the first rotation stop part Ma is also referred to as a “first spline part Sa”. Note that the input member BI is not moved (slid) in the direction of the rotation axis line Ja.

The output member BO (in particular, one end portion) is a rotating member (member rotatable with respect to the housing HG) having the first screw part Na on the outer periphery (cylindrical outer periphery) Mg. In addition to the first screw part Na, a second rotation stop part Mb capable of engaging with the first rotation stop part Ma is provided on the outer periphery Mg of one end portion of the output member BO. That is, the first and second rotation stop parts Ma and Mb configure a rotation-stop mechanism MD. The movement of the output member BO is restrained by the engagement between the first rotation stop part Ma and the second rotation stop part Mb. That is, the output member BO is rotatable around the pressing axis line Ja with respect to the housing HG and can linearly move along the pressing axis line Ja.

As illustrated in the blowout part (A), in the output member BO, when the first rotation stop part Ma is formed as a spline internal tooth, the second rotation stop part Mb is formed (processed) as a spline external tooth. In this case, the second rotation stop part Mb is also called a “second spline part Sb”. Further, a male screw Oj (in a trapezoidal screw) is formed (processed) as the first screw part Na. The second rotation stop part Mb (second spline part Sb) merely needs to be formed within a range (referred to as a “movable range”) in which the output member BO can move relative to the input member BI. However, in the example shown in the blowout part (A), the second spline part Sb is processed over the entire region of the male screw Oj. With such a configuration, processing of the second spline part Sb can be facilitated.

The first linear motion member BH is a non-rotating member in which movement in the rotating direction around the pressing axis line Ja is restrained, and is a linear motion member that can move only along the pressing axis line Ja. Here, the restraint in the rotary motion is achieved by sliding contact (e.g., two chamfering which are sliding contacts on two planes) between the plane of the outer periphery of the first linear motion member BH and the plane of the inner periphery of the housing HG. Alternatively, the rotary motion may be restrained by a spline mechanism or a key mechanism.

The first linear motion member BH has a cylindrical inner periphery Mh. A second screw part Nb engageable with the first screw part Na is formed (processed) in the cylindrical inner periphery Mh of the first linear motion member BH. That is, the first and second screw parts Na and Nb form the screw mechanism NJ. For example, when the male screw Oj is formed as the first screw part Na, the female screw Mj (in a trapezoidal screw) is formed (processed) as the second screw part Nb. The first pressing part Pa is provided on the opposite side of the cylindrical inner periphery (part where the second screw part Nb is provided) Mh of the first linear motion member BH. The first pressing part Pa engages with a brake shoe on the leading side (referred to as a “reading shoe”) BSa to press (i.e., apply the pressing force Fs) the leading shoe BSa. The first linear motion member BH is provided with a pressing force sensor FS so as to detect the pressing force Fs.

The second linear motion member BJ is provided on the side opposite to the first linear motion member BH with respect to the output member BO in the pressing axis line Ja. Similarly to the first linear motion member BH, the second linear motion member BJ is a non-rotating member whose movement in the rotating direction is restrained by planar sliding contact (two chamfering etc.). The second linear motion member BJ is also movable only in the direction along the pressing axis line Ja. For example, the second linear motion member BJ is provided with a depressed part, and the other end portion of the output member BO is fitted into the depressed part. The end face Mo of the output member BO presses the bottom surface Mc of the second linear motion member BJ while rotating. The second pressing part Pb is provided on the side opposite to the depressed part of the second linear motion member BJ. The second pressing part Pb engages with a brake shoe on the trailing side (referred to as a “trailing shoe”) BSb to press (i.e., apply the pressing force Fs) the trailing shoe BSb. Here, the pressing forces Fs acting on the first and second pressing parts Pa and Pb have an action/reaction relationship. Therefore, the pressing force sensor FS may be provided on the second linear motion member BJ.

The screw mechanism NJ formed by the first and second screw parts Na and Nb has reverse efficiency. The screw mechanism NJ not only transmits power of the electric motor MT to the first and second linear motion members BH and BJ, but also transmits power from the first and second linear motion members BH and BJ toward the electric motor MT. That is, bidirectional power transmission can be performed via the screw mechanism NJ.

### Parking Brake Mechanism PK

The parking braking force Fp is maintained even if the energization to the electric motor MT is stopped by the parking brake mechanism PK. The parking brake mechanism PK includes a ratchet gear RC, a pawl member TS, and a solenoid SL. The ratchet gear RC is fixed to the output shaft SM of the electric motor MT. The pawl member TS is provided so as to mesh with the ratchet gear RC. The pawl member TS is driven by the solenoid SL. Similarly to the electric motor MT, the solenoid SL is controlled by the controller ECU.

### Controller ECU

The controller electronic control unit (ECU) controls the electric motor MT and drives the actuator DN. The controller ECU includes a vehicle body side controller ECB, a wheel side controller ECW, and a communication bus BS. The vehicle body side controller ECB is a controller provided on the vehicle body side, and the wheel side controller ECW is a controller (e.g., built in the electric actuator DN) provided on the wheel side. The vehicle body side controller ECB and the wheel side controller ECW are connected via the communication bus BS so that signals (detected value, calculated value, etc.) can be mutually transmitted and received.

The controller ECU (vehicle body side and wheel side controllers ECB, ECW) includes an electric circuit board on which a microprocessor MP or the like is mounted and a control algorithm programmed in the microprocessor MP. The electric motor MT is controlled based on the control algorithm in the microprocessor MP. Furthermore, the wheel side controller ECW includes a driving circuit DR to drive the electric motor MT. In the driving circuit DR, a bridge circuit is formed by switching elements (power semiconductor devices such as MOS-FET and IGBT). The energization amount to the electric motor MT is controlled through the bridge circuit, and the electric motor MT is driven. The driving circuit DR is provided with an energization amount sensor IA (not illustrated) that detects an actual energization amount Ia of the electric motor MT. For example, a current sensor is adopted as the energization amount sensor IA, and the supply current Ia to the electric motor MT is detected.

A braking operation amount Ba (operation amount of a braking operation member BP) detected by a braking operation amount sensor BA (e.g., displacement sensor of the braking operation member BP), and a parking signal Sw (signal representing the operation state of a parking brake switch SW) which is the output signal of the parking brake switch SW are input to the vehicle body side controller ECB. The actuation of a service brake (also referred to as “normal braking”) is performed based on the braking operation amount Ba, and the actuation of the parking brake is performed based on the parking signal Sw.

### Actuation of Service Brake

In the power conversion mechanism HN of FIG. 2, the state (a) illustrated above the pressing axis line Ja corresponds to the “state at the time of non-braking”, and the state (b) illustrated below the pressing axis line Ja corresponds to the “state at the time of braking”. In the state (a) at the time of non-braking, the brake shoes BSa (leading shoe) and BSb (trailing shoe) are pulled by the return member (return spring) RS, and thus the brake lining MS is separated from the friction surface Md of the brake drum BD. In the state (b) at the time of braking, the leading side and trailing side brake shoes BSa and BSb are pressed by the first and second pressing parts Pa and Pb, and thus the brake lining MS presses the friction surface Md thus generating a friction force. Here, the direction in which the first pressing part Pa of the first linear motion member BH and the second pressing part Pb of the second linear motion member BJ separate along the pressing axis line Ja is referred to as an “expanding direction Ha”, and corresponds to the direction in which the braking forces Fx and Fp increase. Conversely, the direction in which the first pressing part Pa and the second pressing part Pb approach each other is referred to as a “reducing direction Hb”, and corresponds to a direction in which the braking forces Fx and Fp decrease.

When the operation of the braking operation member (e.g., brake pedal) BP is started, the braking operation amount Ba is increased from “0”. In the vehicle body side controller ECB, a target pressing force Ft is calculated to increase according to the increase in the braking operation amount Ba based on the calculation map set in advance and the braking operation amount Ba. Here, the target pressing force Ft is a target value of the actual pressing force Fs. The target pressing force Ft is transmitted from the vehicle body side controller ECB to the wheel side controller ECW via the communication bus BS.

In the wheel-side controller ECW, the electric motor MT is controlled based on the target pressing force Ft such that the actual pressing force Fs (detected value of the pressing force sensor FS) matches the target pressing force Ft. Specifically, a target energization amount It is calculated so as to increase according to the increase in the target pressing force Ft based on a calculation map set in advance and the target pressing force Ft. Furthermore, a deviation hF between the target pressing force Ft and the actual pressing force Fs is calculated, and the target energization amount It is adjusted according to the pressing force deviation hF. Here, the target energization amount It is a target value of the energization amount Ia with respect to the electric motor MT. Based on the target energization amount It, the driving circuit DR is controlled such that the actual energization amount Ia (detected value of the energization amount sensor IA) matches the target energization amount It, and the electric motor MT is driven.

When the electric motor MT is driven, rotation power (output torque of the electric motor MT) is generated by the electric motor MT. The rotation power is transmitted to the power conversion mechanism HN via the speed reducer GS. Specifically, the rotation power of the electric motor MT is transmitted to the input member BI to which the second large-diameter gear DK2 of the speed reducer GS is fixed. A first rotation stop part Ma is provided on the inner periphery Mn of the input member BI. The output member BO is inserted into the inner periphery Mn of the input member BI. A second rotation stop part Mb is formed on the outer periphery Mg of the output member BO so as to mesh with the first rotation stop part Ma. Therefore, the input member BI and the output member BO are integrally rotated by the rotation power of the electric motor MT.

One end portion of the output member BO is inserted into the inner periphery Mh of the first linear motion member BH. A first screw part Na is formed on the outer periphery Mg of one end portion of the output member BO. A second screw part Nb is formed on the inner periphery Mh of the first linear motion member BH so as to mesh with the first screw part Na. The first linear motion member BH is movable in the direction of the pressing axis line Ja with respect to the housing HG, but its movement is limited (restrained) so as not to rotate around the pressing axis line Ja. For example, the limitation in the movement of the first linear motion member BH is achieved by planar sliding (two chamfering, etc.), a spline mechanism, a key mechanism, or the like. Since the first linear motion member BH is movable only in the direction of the pressing axis line Ja, when the first screw part Na is rotated, the first linear motion member BH is relatively moved in the expanding direction Ha (leftward direction in the drawing, which is a direction away from the input member BI) (see state (b)).

The other end portion of the output member BO is inserted into the depressed part of the second linear motion member BJ. The end face Mo of the other end portion of the output member BO abuts on the bottom surface Mc of the depressed part of the second linear motion member BJ. Since the second linear motion member BJ is also movable only in the direction of the pressing axis line Ja, when the first screw part Na is rotated, the second linear motion member BJ is relatively moved in the expanding direction Ha (rightward direction in the drawing, which is a direction away from the input member BI.) (see state (b)).

As described above, when the braking operation amount Ba is increased and the electric motor MT is driven in the forward rotation direction, the first pressing part Pa and the second pressing part Pb are moved in the expanding direction Ha so as to separate from each other by the rotation power of the electric motor MT. As a result, the leading shoe BSa and the trailing shoe BSb are pressed by the pressing force Fs, and the brake lining MS is pressed against the friction surface Md. At this time, the friction surface Md of the brake drum BD rotates in the direction Da corresponding to the straight advancing direction of the vehicle, and thus a friction force is generated between the brake lining MS and the friction surface Md, and as a result, the braking force Fx is generated.

When the braking operation amount Ba is decreased, the electric motor MT is driven in the reverse rotation direction. Thus, the first linear motion member BH (i.e., first pressing part Pa) and the second linear motion member BJ (i.e., second pressing part Pb) are moved in the approaching direction (i.e., reducing direction Hb). As a result, the pressing force Fs is reduced, the friction force between the brake lining MS and the friction surface Md is reduced, and the braking force Fx is reduced. Note that a force against the pressing force Fs acts between the leading shoe BSa and the trailing shoe BSb by the return member (return spring) RS. Therefore, when the braking operation amount Ba is reduced, the friction force is reduced while the engagement state between the first and second pressing parts Pa and Pb and the brake shoes BSa and BSb (in particular, the sites Qa, Qb) is maintained.

### Actuation of Parking Brake

In a state where the vehicle is stopped (i.e., the brake drum BD is not rotating), the driver operates the parking brake switch SW to switch the parking signal Sw from off to on. Energization of the electric motor MT is started, and the electric motor MT is rotationally driven in the forward rotation direction. The rotation power is transmitted to the power conversion mechanism HN via the speed reducer GS, and the brake lining MS is pressed against the friction surface Md. When the pressing force Fs reaches a predetermined pressing force fp, the energization amount to the electric motor MT is maintained, and the pressing force Fs is maintained constant. Here, the predetermined pressing force fp is a preset constant and is a control threshold value. When the state in which the pressing force Fs is held is continued for a predetermined time tp, the solenoid SL is energized, and the pawl member TS is meshed with the ratchet gear RC. The ratchet gear RC has teeth having directionality for limiting the actuating direction to one direction. Therefore, once the pawl member TS and the ratchet gear RC are meshed with each other, the state of “Fs = fp” is maintained even if the energization to the electric motor MT is stopped. That is, the parking brake function is exerted by the electric actuator DN.

When the parking signal Sw is switched from on to off, the release operation of the parking brake control is performed. In the release operation, the electric motor MT is driven to rotate forward. As a result, the pawl member TS goes over the tooth tip of the ratchet gear RC, and the engagement between the pawl member TS and the ratchet gear RC is released. Then, a transition is made from a state in which the parking brake is effective to a state in which the parking brake is not effective.

### Effect of Miniaturizing Power Conversion Mechanism HN

The power conversion mechanism HN that converts the rotary motion of the electric motor MT into the linear motion using the screw mechanism NJ requires two mechanisms of the screw mechanism NJ and the rotation-stop mechanism MD. As described in Patent Literature 1, in the configuration in which the screw mechanism NJ and the rotation-stop mechanism MD are separately formed and the screw mechanism NJ is provided on the inner peripheral side of the rotation-stop mechanism MD, the dimension in the direction perpendicular to the rotation axis line (center axis line) (i.e., the radial direction) is increased. On the other hand, in a configuration in which the screw mechanism NJ and the rotation-stop mechanism MD are formed separately and the screw mechanism NJ and the detent mechanism MD are provided side by side on the rotation axis line, the dimension in the direction of the rotation axis line (i.e., the axial direction) increases.

In the electric actuator DN according to the present disclosure, the screw mechanism NJ (Na + Nb) and the rotation-stop mechanism MD (Ma + Mb) are not separately provided, but these mechanisms are integrally provided on the outer periphery Mg of the output member BO. Therefore, in the power conversion mechanism HN of the electric actuator DN, the dimensions in the radial direction and the axial direction are shortened, and as a result, the entire device can be miniaturized.

### First Example of Power Conversion Mechanism HN

In the electric actuator DN according to the present disclosure, the first screw part Na (a part of the screw mechanism NJ) and the first rotation stop part Ma (a part of the rotation-stop mechanism MD) are provided on the outer periphery Mg of the output member BO. Since the output member BO has two functions of the screw mechanism NJ and the rotation-stop mechanism MD, the electric actuator DN (in particular, the power conversion mechanism HN) is miniaturized in both the radial direction and the axial direction. However, in order to serve two functions, consideration on strength and function is required for the screw mechanism NJ and the rotation-stop mechanism MD. This will be described below.

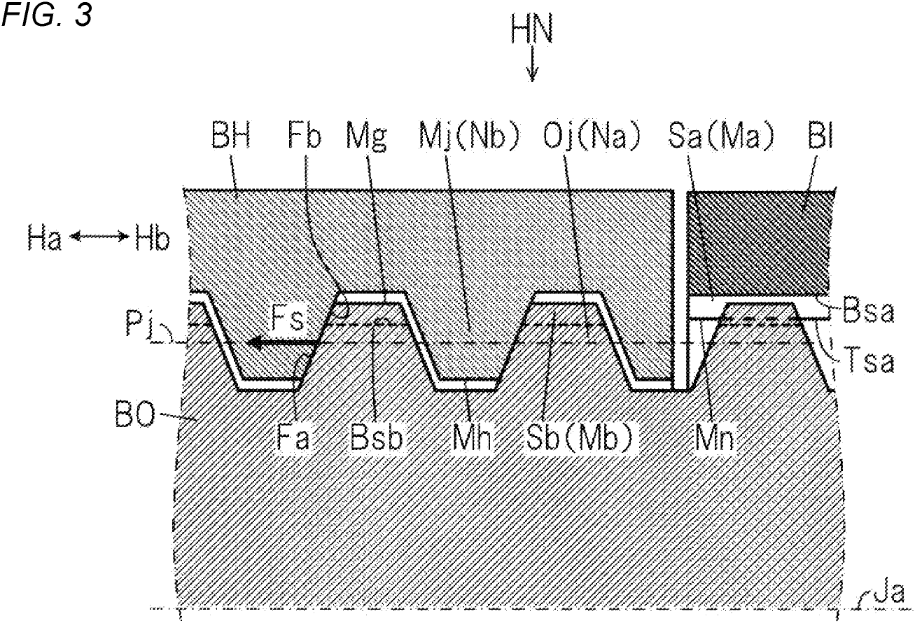

A first example of the power conversion mechanism HN of the electric actuator DN will be described with reference to a partial cross-sectional view of FIG. 3. In the first example, a trapezoidal screw (male screw Oj, female screw Mj) is adopted as the screw mechanism NJ, and a spline mechanism (first and second spline parts Sa, Sb) is adopted as the rotation-stop mechanism MD.

In the input member BI in which the second large-diameter gear DK2 is provided on the outer periphery, a first spline part Sa is formed as the first rotation stop part Ma on the inner periphery Mn. on the inner periphery Mn of the input member BI, spline internal teeth are processed to form a first spline part Sa (i.e., the first rotation stop part Ma). That is, the inner periphery Mn of the input member BI is a spline hole. A second spline part Sb that can engage with the first spline part Sa is provided as a second rotation stop part Mb on the outer periphery Mg at one end portion of the output member BO. That is, the spline external teeth are processed on the outer periphery Mg of the one end portion of the output member BO to form the second spline part Sb (i.e., the second rotation stop part Mb). That is, one end portion of the output member BO is a spline shaft. The first and second spline parts Sa and Sb configure a rotation-stop mechanism MD, and the movement of the output member BO is restricted. Specifically, the output member BO is rotatable around the pressing axis line Ja with respect to the housing HG, and can linearly move in the direction of the pressing axis line Ja.

A male screw Oj is formed as a first screw part Na on an outer periphery Mg of one end portion of the output member BO. The male screw Oj of the output member BO is meshed with the female screw Mj formed on the inner periphery Mh of the first linear motion member BH. The female screw Mj of the first linear motion member BH is formed as a second screw part Nb. The male screw Oj and the female screw Mj configure a screw mechanism NJ using a trapezoidal screw. The trapezoidal screw mechanism NJ transmits the rotation power of the electric motor MT to the brake shoes BSq and BSb. Specifically, the flank Fa of the male screw Oj presses the flank Fb of the female screw Mj in the expanding direction Ha, so that the pressing force Fs is transmitted (so-called power transmission by sliding).

In the spline mechanism, a spline shaft (corresponding to the output member BO) having a plurality (a large number) of external teeth on an outer periphery is engaged with a spline hole (corresponding to the input member BI) having internal teeth. In the spline mechanism, since power is transmitted by a plurality of teeth, a tooth height thereof can be set relatively small. In the power conversion mechanism HN, the tooth height of the trapezoidal screw (male screw Oj, female screw Mj) and the tooth height of the spline mechanism (external teeth, internal teeth) are basically arbitrary, but the tooth height of the spline (height difference between mountain top portion Tsa and valley bottom portion Bsa in internal tooth) is desirably set to be smaller than the tooth height of the trapezoidal screw (height difference between mountain top portion and valley bottom portion in male screw Oj). Furthermore, in a state where the power conversion mechanism HN is assembled, the mountain top portion Tsa of the spline internal tooth may be set to be located on the outer side of the pitch circle line Pj of the male screw Oj with respect to the pressing axis line Ja.

### Second Example of Power Conversion Mechanism HN

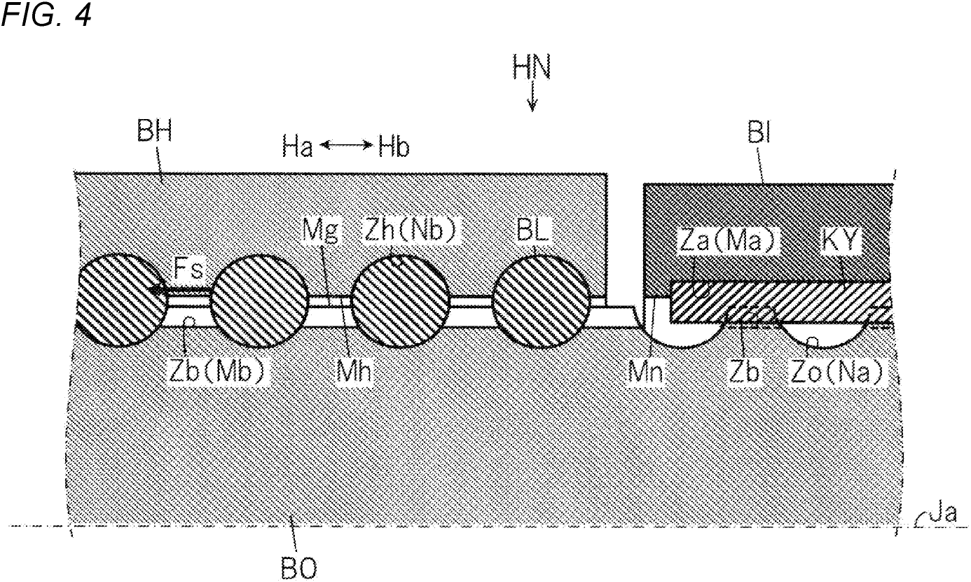

A second example of the power conversion mechanism HN of the electric actuator DN will be described with reference to a partial cross-sectional view of FIG. 4. In the second example, a ball screw (Zo + Zh + BL) is adopted as the screw mechanism NJ, and a key mechanism (Za + Zb + KY) is adopted as the rotation-stop mechanism MD. Similarly to the trapezoidal screw, a ball screw having reverse efficiency is adopted as the screw mechanism NJ.

A first key groove part Za is formed as the first rotation stop part Ma on the inner periphery Mn (center hole) of the input member BI. A second key groove part Zb is formed as the second rotation stop part Mb on the outer periphery Mg of the output member BO. The key member KY is fitted into the first and second key groove parts Za and Zb to form the rotation-stop mechanism MD. Similarly to the first example, the output member BO can rotate around the pressing axis line Ja with respect to the housing HG, and can linearly move along the pressing axis line Ja.

A ball screw groove (male screw groove) Zo is formed as the first screw part Na in the cylindrical outer periphery Mg of one end portion of the output member BO. A ball screw groove (female screw groove) Zh is formed as the second screw part Nb in the cylindrical inner periphery Mh of the first linear motion member BH. A plurality of balls BL are fitted into the ball screw grooves Zo and Zh. The male screw groove Zo, the female screw groove Zh, and the ball BL configure a screw mechanism NJ using a ball screw. In the ball screw mechanism NJ, the rotation power of the electric motor MT is transmitted to the brake shoes BSq and BSb via the balls BL (so-called power transmission by rolling).

In the ball screw mechanism NJ, since the power is transmitted when ball BL is moved (circulated) in the ball screw grooves Zo and Zh, it is necessary for the ball BL to smoothly roll in the ball screw grooves Zo and Zh. Therefore, the depth of the key groove (first and second key grooves) is desirably set to be shallower (smaller) than the depth of the ball screw groove. In this case, the dimension (dimension in the perpendicular direction with respect to the pressing axis line Ja of the key member KY in a state where the key member KY is assembled to the key groove) of the key member KY in the radial direction with respect to the rotation axis line Ja is smaller than the diameter of the ball BL. By setting the dimensional relationship between the key member KY and the key groove in this manner, even when the ball BL passes across the key grooves Za and Zb, the ball BL can roll smoothly.

### Operation and Effect of Electric Actuator DN

The electric actuator DN includes “an input member BI that is rotationally driven by the electric motor MT and has a first rotation stop part Ma on the inner periphery Mn”, “an output member BO including a second rotation stop part Mb that is engageable with the first rotation stop part Ma and a first screw part Na on the outer periphery Mg”, and “a linear motion member BH including a second screw part Nb engageable with the first screw part Na”.

The screw mechanism NJ (Na + Nb) and the rotation-stop mechanism MD (Ma + Mb) are not provided separately, but the outer periphery Mg of the output member BO serves as both the screw mechanism NJ and the rotation-stop mechanism MD. Therefore, in the power conversion mechanism HN of the electric actuator DN, the radial and axial dimensions are shortened, and the entire device can be miniaturized.

In the electric actuator DN, a male screw Oj (in a trapezoidal screw) is adopted as the first screw part Na, and a female screw Mj (in a trapezoidal screw) is adopted as the second screw part Nb. That is, a trapezoidal screw is adopted as the screw mechanism NJ. This is because the trapezoidal screw is simple in structure and has a large power transmission capacity. The device is miniaturized and the cost is reduced by adopting the trapezoidal screw.

In the electric actuator DN, the spline mechanisms Sa and Sb are adopted for the first and second rotation stop parts Ma and Mb. In the spline mechanisms Sa and Sb (first and second spline parts), power transmission is performed by the plurality of spline teeth, and hence the power transmission capacity is large. The device can be miniaturized by adopting the spline mechanisms Sa and Sb.

The electric actuator DN is applied to the electric braking device DS that converts the rotation power of the electric motor MT into linear power, presses the brake lining MS provided on the brake shoes BSa and BSb against the brake drum BD by the linear power, and generates the braking force Fx (or Fp) on the wheel. The space around the wheels of the vehicle is narrow and very limited. Mountability in a narrow space can be improved in the electric braking device DS by adopting the miniaturized electric actuator DN.

### Other Embodiments

As described above, in the electric actuator DN, the configuration of the “trapezoidal screw + spline mechanism” is shown in the first example, and the combination configuration of the “ball screw + key mechanism” is shown in the second example. Instead of these combinations, a combination of a “trapezoidal screw serving as the screw mechanism NJ” and a “key mechanism serving as the rotation-stop mechanism MD” may be adopted. In this combination as well, the same effects as described above (miniaturization of the device) are obtained.

1. An electric actuator comprising:
an input member that is rotationally driven by an electric motor and includes a first rotation stop part on an inner periphery;
an output member including a second rotation stop part engageable with the first rotation stop part and a first screw part on an outer periphery; and
a linear motion member including a second screw part engageable with the first screw part.

2. The electric actuator according to claim 1, wherein
the first screw part is a male screw and the second screw part is a female screw.

3. The electric actuator according to claim 2, wherein
the first and second rotation stop parts are spline mechanisms.

4. An electric braking device for a vehicle that converts rotation power of an electric motor into linear power and presses a brake lining provided on a brake shoe against a brake drum by the linear power to generate braking force on a wheel, the electric braking device comprising:
a power conversion mechanism that converts the rotation power into the linear power, the power conversion mechanism being configured by,
an input member including a first rotation stop part on an inner periphery,
an output member including a second rotation stop part engageable with the first rotation stop part and a first screw part on an outer periphery, and
a linear motion member including a second screw part engageable with the first screw part.

5. The electric actuator according to claim 1, wherein the first and second rotation stop parts are spline mechanisms.
